(19) United States
(12) Patent Application Publication
(10) Pub. No.: US 2019/0384838 A1
(43) Pub. Date: Dec. 19, 2019

(54) METHOD, APPARATUS AND COMPUTER PROGRAM FOR PROCESSING DIGITAL ITEMS

(71) Applicant: Microsoft Technology Licensing, LLC, Redmond, WA (US)

(72) Inventors: Audun Østrem NORDAL, Tromsø (NO); Kai-Marius Sæther PEDERSEN, Tromsø (NO); Vegar Skjærven WANG, Tromsø (NO)

(21) Appl. No.: 16/011,736

(22) Filed: Jun. 19, 2018

(51) Int. Cl. G06F 17/30

(52) U.S. Cl. CPC G06F 17/30321; G06F 17/3053; G06F 17/30867

(57) ABSTRACT

Content in a digital item is analyzed to identify individual terms. A count of at least some of the individual terms is obtained. A measure of the likelihood that the content is or contains natural language is obtained based on the count of at least some of the individual terms. If the measure of the likelihood that the content of the digital item is or contains natural language is above a threshold, the content of the digital item is forwarded to an indexer of a search engine. Otherwise, if the measure of the likelihood that the content of the digital item is or contains natural language is below the a threshold, the content of the digital item is not forwarded to the indexer or the content of the digital item is forwarded to the indexer together with the measure of the likelihood.

### TECHNICAL FIELD

The present disclosure relates to a method, apparatus and computer program for processing digital items.

### BACKGROUND

Search engines are used in many applications to enable searches through digital items to be carried out. For example, Web search engines, which enable (human) users to search for specific content on the World Wide Web, are well known and familiar. Search engines are also used in other applications, including for example to enable searches to be carried out on a personal computer (a “desktop search”), in databases, etc. The search results are often presented in the form of a list and are commonly called “hits”. Search engines help to minimize the time required to find information and the amount of information that must be consulted by a (human) user. However, the digital items may contain only natural language textual content, may contain only non-natural language textual data, or may contain non-natural language textual data that is hosted side-by-side with natural language textual content within the digital item. Either way, the presence of both non-natural language textual data and natural language textual content presents a number of problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

According to a first aspect disclosed herein, there is provided a method of processing digital items, the method comprising: analyzing content in a digital item to identify individual terms in the content of the digital item; obtaining a count of at least some of the individual terms in the content of the digital item; obtaining a measure of the likelihood that the content of the digital item is or contains natural language based on the count of at least some of the individual terms in the content of the digital item; and if the measure of the likelihood that the content of the digital item is or contains natural language is above a threshold, forwarding the content of the digital item to an indexer of a search engine, the search engine indexer then indexing the content of the digital item such that said content is available to a search engine; and if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

Examples described herein provide a number of advantages. For example, the precision of a search may be better in that search results that are not likely to be of interest to a user may be omitted or penalized in ranking (when for example non-natural language text is not indexed or when non-natural text is indexed but is identified as such). As another example, if natural and non-natural language is mixed, sections of the items that are considered to be natural language may be marked-up or highlighted. As another example, in the case that non-natural language text is not indexed, the operational cost of producing and maintaining a search index may be lower as the size of the index is smaller than it would otherwise have been.

“Highlighting” here means “draw special attention to”. That is, results that are likely to be natural language may be highlighted relative to results that are likely not to be natural language. A number of options for this are possible, as discussed further below.

In an example, the method comprises in case (ii) forwarding metadata for the digital item to the search engine indexer, the search engine indexer then indexing the metadata.

The metadata may be returned in search results by the search engine in response to a search query, even though the content itself is not returned. In that way, a user who is viewing the search results can at least be made aware of the existence of the digital item. The metadata may be for example the file name of the digital item.

In an example, content for which the measure of the likelihood is above the threshold is highlighted in the search results relative to content for which the measure of the likelihood is below the threshold ranking by ranking content for which the measure of the likelihood is above the threshold higher in the search results than content for which the measure of the likelihood is below the threshold ranking.

In an example, content for which the measure of the likelihood is above the threshold is highlighted in the search results relative to content for which the measure of the likelihood is below the threshold ranking by indicating in the search results the measure of the likelihood.

The measure of the likelihood may for example be indicated in the search results only for content for which the measure of the likelihood is below the threshold. This avoids cluttering search results where the content is likely to be natural language, and only highlights content that is unlikely to be natural language.

In an example, forwarding the content of the digital item to the search engine indexer if the measure of the likelihood that the content of the digital item is or contains natural language is above a threshold comprises: forwarding the content of the digital item and the measure of the likelihood to the search engine indexer.

The search engine can for example indicate the measure of the likelihood for the content that is likely to be natural language in response to a search query.

In an example, the digital item has plural sections of content, and the plural sections of content are processed independently.

In an example, obtaining the measure of the likelihood that the content of the digital item is or contains natural language is based on the distribution of the count of at least some of the individual terms in the content of the digital item.

In an example, obtaining a measure of the likelihood that the content of the digital item is or contains natural language based on the count of at least some of the individual terms in the content of the digital item comprises: calculating an entropy of the individual terms in the content of the digital item based on the count of at the least some of the individual terms in the content of the digital item.

In an example, the method comprises: determining that the measure of the likelihood that the content of the digital item is or contains natural language is below a threshold if the entropy is above a first entropy threshold or lower than a second, lower entropy threshold, and determining that the measure of the likelihood that the content of the digital item is or contains natural language is above a threshold if the entropy is between the first entropy threshold and the second entropy threshold.

According to a second aspect disclosed herein, there is provided a computer program comprising a set of computer-readable instructions, which, when executed by a computer system, cause the computer system to carry out a method of processing of digital items, the method comprising:

analyzing content in a digital item to identify individual terms in the content of the digital item;

obtaining a count of at least some of the individual terms in the content of the digital item;

obtaining a measure of the likelihood that the content of the digital item is or contains natural language based on the count of at least some of the individual terms in the content of the digital item; and

if the measure of the likelihood that the content of the digital item is or contains natural language is above a threshold, forwarding the content of the digital item to an indexer of a search engine, the search engine indexer then indexing the content of the digital item such that said content is available to a search engine; and

if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

There may be provided a non-transitory computer-readable storage medium storing a computer program as described above.

According to a third aspect disclosed herein, there is provided a computer system comprising:

at least one processor;

and at least one memory including computer program instructions;

the at least one memory and the computer program instructions being configured to, with the at least one processor, cause the computer system to carry out a method of processing digital items, the method comprising:

analyzing content in a digital item to identify individual terms in the content of the digital item;

obtaining a count of at least some of the individual terms in the content of the digital item;

obtaining a measure of the likelihood that the content of the digital item is or contains natural language based on the count of at least some of the individual terms in the content of the digital item; and

if the measure of the likelihood that the content of the digital item is or contains natural language is above a threshold, forwarding the content of the digital item to an indexer of a search engine, the search engine indexer then indexing the content of the digital item such that said content is available to a search engine; and

if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a computer system according to some examples described herein and a user interacting with the computer system;

FIG. 2 shows schematically another representation of a computer system according to some examples described herein;

FIG. 3 shows a schematic flow diagram of an example of a method of operation of a computer system according to examples described herein;

FIG. 4 shows a schematic flow diagram of an example of calculating a measure of likelihood; and

FIG. 5 shows a schematic flow diagram of another example of calculating a measure of likelihood.

### DETAILED DESCRIPTION

In some examples described herein, a search engine is provided to enable searches through digital items to be carried out. The search engine may be for example a Web search engines, which enables human users (hereafter simply “users”) to search for specific content on the World Wide Web. In other examples, the search engine is used in other applications, for example to enable searches to be carried out on a personal computer (a “desktop search”), in a database, etc. The search results may be presented in the form of a list and are commonly called “hits”. Search engines help to minimize the time required to find information and the amount of information that must be consulted.

The digital items may contain only natural language textual content, may contain only non-natural language textual data, or may contain non-natural language textual data that is hosted side-by-side with natural language textual content within the digital item. Either way, the presence of both non-natural language textual data and natural language textual content in the data items presents a number of problems. Examples of non-natural language textual data include collections of measurements or calculations, be they scientific, engineering or financial, or computer programs or listings, or audio, image or video data that is encoded in a way that can be represented as text, etc. In all these scenarios, the non-natural language textual data can be represented in a way that is not immediately discernible (at least by known computer systems) from natural language text without a dictionary or perhaps lexical analysis, for instance if the data is represented with characters from the English alphabet with space separators at some frequency.

A user would normally not want to search for non-natural language items by their contents, and if a user receives a non-natural language item for a natural language query term, the item is likely to be regarded as “noise” and reduces the relevance and the precision of the search for the users. In addition, the presence of non-natural language text adds to the search engine overhead both in terms of the fixed cost per indexed items and the dynamic cost per searchable term (where “cost” can be measured in terms of for example processor time required to process the data). In addition, if these non-natural language items by chance contain popular terms (which may or may not be real words), they can artificially inflate the set of items returned for that term, while likely not actually being relevant to that term. What may appear as a natural language word may instead be some data representation that by chance was encoded to a symbol that happened to also be a natural language word.

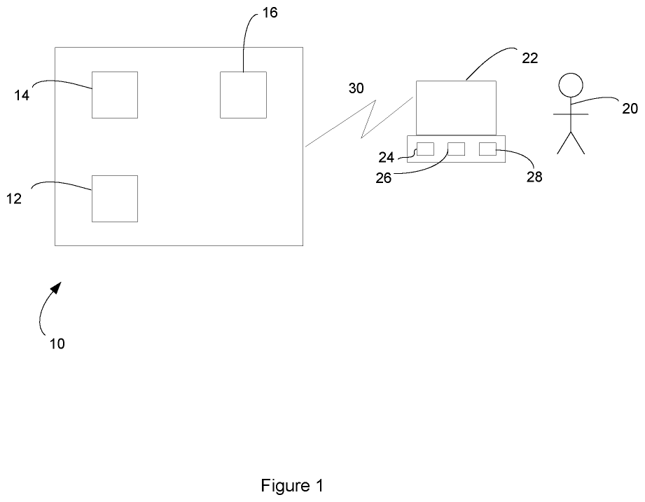

Referring now to FIG. 1, this shows schematically an example of a computer system 10 with which one or more users 20 can interact via user computers 22 according to an example of the present disclosure. The computer system 10 has one or more processors 12, working memory or RAM (random access memory) 14, which is typically volatile memory, and persistent (non-volatile) storage 16. The persistent storage 16 may be for example one or more hard disks, non-volatile semiconductor memory (e.g. a solid-state drive or SSD), etc. The computer system 10 may be provided by one individual computer or a number of individual computers. The user computers 22 likewise have the usual one or more processors 24, RAM 26 and persistent storage 28. The user computers 22 can interact with the computer system 10 over a network 30, which may be one or more of a local area network and the Internet, and which may involve wired and/or wireless connections. Whilst the computer system 10 and the user computers 22 are shown as separate devices in FIG. 1, the computer system 10 may in other examples be implemented as a user computer such that the user simply interacts directly with the computer system 10.

The computer system 10 has a number of components, which may be implemented in software or hardware or a mixture of software and hardware. The separate components may all be implemented on the same processor 12 or by separate processors 12, optionally by separate processors 12 in separate computer systems 10 in a manner known per se.

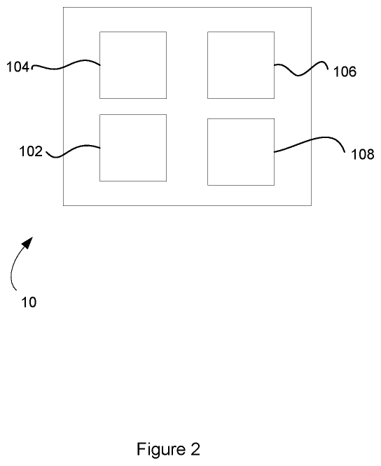

Referring to FIG. 2, this shows a representation of the computer system 10 to indicate schematically examples of components which may be used in examples described herein. The computer system 10 has a first component 102 which identifies content for indexing. Such a component is commonly known as a “crawler” 102. The computer system 10 has a second component 104 which operates on the content (to be discussed further below). The computer system 10 has a third component 106, which creates a searchable representation of at least some of the content. Such a component is commonly known as an “indexer” 106 and the searchable representation of the content is commonly known as an “index”. The computer system 10 has a fourth component 108, which accepts a search query from a user 20 and, from the index, returns a set of items that match the query. Such a component is commonly known as a “search engine” 108.

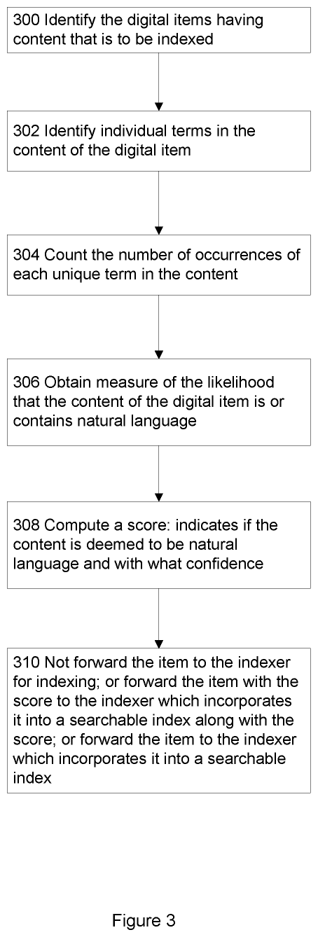

Referring additionally to FIG. 3, which shows a schematic flow diagram of an example of a method of operation of the computer system 10, in a first, preliminary phase 300, the crawler 102 identifies the digital items having content that is to be indexed. Depending on the application, the crawler 102 may be one of a different number of types, and can access the content in a number of different ways and based on different criteria. For example, a Web crawler starts with a list of URLs (Uniform Resource Locators) to visit. As the Web crawler visits these URLs, it identifies all the hyperlinks in the page and adds them to the list of URLs to visit, called the “crawl frontier”. URLs from the frontier are recursively visited according to a set of policies. The content from the URLs is then collected by the crawler 102 and returned to the computer system 10. On the other hand, in a local (non-Web) crawler 102, the crawler 102 accesses data that is stored locally, whether on the computer system 10 on which the crawler 102 is implemented or in some other data storage that is locally accessible to the crawler 102. Crawlers as such are well known to the person skilled in the art. As will be clear, the digital items may in general contain only natural language textual content, may contain only non-natural language textual data, or may contain non-natural language textual data that is hosted side-by-side with natural language textual content within the digital item.

Once the digital items having content that is (potentially) to be indexed have been identified, at 302 the operating component 104 operates on the digital items. In one example, the operating component 104 creates a representation of the item in which the text in the content is broken up into individual terms. At least some of the terms into which the text is broken may correspond to or be words (that is, words of a natural language). Such a process is often referred to as “tokenization”. It may be noted that tokenizing of Latin scripts/languages is in general relatively straightforward as, as a first step at least, it is necessary only to look for spaces or punctuation characters, which typically separate words in Latin scripts/languages. On the other hand, tokenizing of non-Latin languages, including for example Chinese, Japanese and Korean (“CJK”), is typically a more complex problem. Again, techniques for tokenization in the context of search engines as such are well known to the person skilled in the art.

From the tokenized version of the content, at 304 in this example the operating component 104 counts the number of occurrences of each unique term in the content, or at least the number of occurrences of at least some of the unique terms in the content. For example, after a while of operating on the content, the operating component 104 may have effectively identified the most frequently occurring terms in the content (such as for example the top 50 or 100, etc. most frequently occurring terms) and further operation for a period of time or over a further number of unique terms has not changed that list of most frequently occurring terms in the content.

Based on the count of (at least some of) the individual terms in the content of the digital item, a measure of the likelihood that the content of the digital item is or contains natural language is obtained by the operating component 104 at 306.

In one example, this measure of the likelihood that the content of the digital item is or contains natural language is based on the distribution of the count of the individual terms in the content of the digital item. In one example, the terms are sorted according to the number of occurrences of the terms, with the most frequent term first. This forms a histogram of (term, count) tuples. The shape of the histogram may be used to determine if the content is likely natural language text or not. Informally, a quickly falling slope followed by a long tail is indicative of natural language text, whereas a flatter slope is indicative of the opposite. Another way of visualizing this is as a probability distribution of the terms. At one extreme, content that is in essence substantially random will yield a completely uniform distribution. On the other hand, natural language text will tend more towards a normal (Gaussian) distribution. Indeed, words (terms) in natural language text break down into fairly predictable frequency distributions. While this distribution will not be the same for different languages, it differs distinctly from non-natural language content. The precision of the approach increases with the amount of input text.

The similarity to a pre-defined natural language distribution is then used at 308 by the operating component 104 in an example to compute a score, indicating if the content is deemed to be natural language, and with what confidence.

One way of calculating this score is by comparing the distribution of the count of the individual terms in the content of the digital item with other distributions, including for example a uniform distribution and a normal distribution, and using some criteria or measure to indicate how close the distribution of the count of the individual terms is to a uniform distribution and a normal distribution.

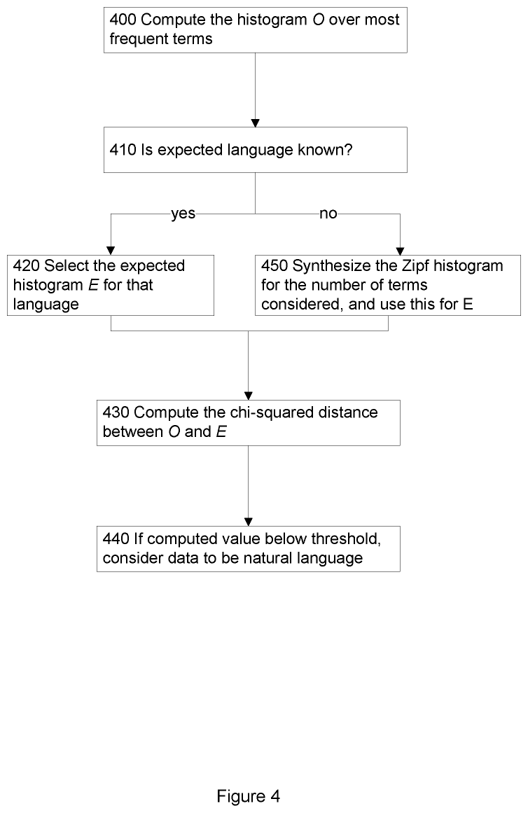

Referring to FIG. 4, as one example of calculating this score, a histogram O of most common or frequently occurring terms in the content is obtained at 400. How one would test if the content stems from natural language depends on whether an expected language is known or not. At 410, therefore, it is checked whether an expected language is known or not

If the expected language is known, then one has an expected histogram E which contains the most common terms of that language and which is selected at 420. Then O and E can be compared using some appropriate test at 430. As an example, the “chi-squared test” may be used at 430. In particular, a value x, which may be treated as a score or measure of the likelihood, may be calculated as:

$${χ}^{2} = {\sum }_{i = 0}^{n} \frac{{( {O}_{i} - {E}_{i} )}^{2}}{{E}_{i}}$$

for the n most common terms in O and/or E. At 430, the value χ² (or equivalently χ) is considered to indicate that the content is natural language if it is below a predefined threshold. The threshold is domain specific, for example related to the expected language, and in general will be different for different languages, and may be tuned or adjusted as necessary.

On the other hand, if the expected language is not known at 410, then in an example it is observed that word frequency tables for most languages follow a Zipf distribution. According to Zipf's law, the frequency of any word is inversely proportional to its rank in the frequency table. In this case, the value E may be synthesized at 450 using the following formula:

$$f ( k ; s , N ) = \frac{1 / {k}^{s}}{{\sum }_{n = 1}^{N} ( 1 / {N}^{s} )}$$

where k is the ith element in E, N is the total number of elements in E, and s is a characterizing exponent that will normally be 1, but which can be tuned for precision. The chi-squared test may then be performed between O and E at 430, but only by evaluating the frequencies and not assessing the term proper.

Another way of obtaining a score or measure of the likelihood is by calculating the “entropy” over the tokenized content, and comparing the entropy to an expected entropy value of natural language. A very high entropy is likely to indicate random data, whereas a very low entropy is likely to indicate that the content has only a small set of unique terms in it, which may be repeated many times. That is, a high or a low calculated entropy indicates that the item is likely not natural language and therefore should have a low score. On the other hand, an entropy falling between upper and lower thresholds is likely to mean that the content is natural language and therefore should have a high score. This can also be beneficial in relation to structured data that contains elements of natural language text, but for instance repeated at a high rate. A naive search engine might deem an item with a repeated term to be especially relevant to that term, whereas in fact it is not relevant. The calculated entropy will however be low, because of the high degree of repetition. Upper and lower thresholds for the entropy may be set depending on for example entropies determined from training sets of data, from known entropies of existing natural languages, etc. In this regard, it may be noted that in principle it is not necessary to know details of different languages beyond a reasonable idea of what a natural language distribution looks like, under the assumption that many or even most languages have a comparable degree of built-in redundancy. Accordingly, the use of the entropy for this purpose as specific advantages in that it is likely to be more generally applicable.

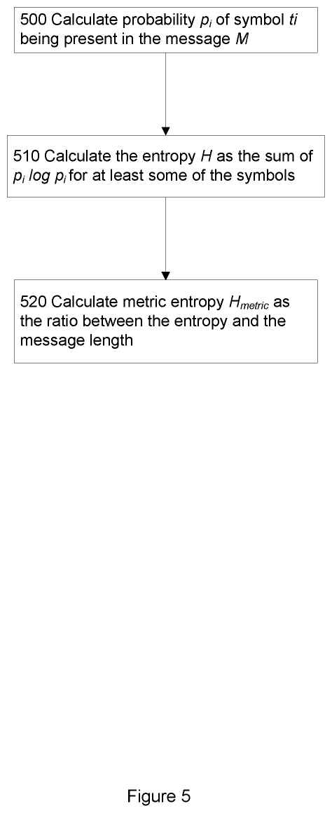

In general, a number of options for defining the entropy are available. In one example, the entropy may be defined as the Shannon entropy as known in information theory. In this example and referring to FIG. 5, consider a message M consisting of terms (for example, words) and from those consider the distinct symbols t₁, t₂, . . . , tₙ. In Shannon entropy, first the probability pᵢ of symbol ti being present in the message M is calculated at 500. The probability pᵢ may then be defined by for example the frequency fᵢ of tᵢ divided by the total number of terms |M|:

$${p}_{i} = \frac{{f}_{i}}{\vert M \vert}$$

The entropy H is then calculated at 510 using at least some of the symbols ti as the sum:

$$H = - {\sum }_{i = 1}^{n} {p}_{i} log {p}_{i}$$

H decreases for lower n, and is 0 for n=1. H is maximized for n=|M|. Due to the redundant nature of natural language, p, is usually not uniform, with certain words (such as the word “the” in English) having an above average value for p.

Considering symbols independently is referred to as a first order entropy. However natural language forms structures, where the likelihood of a given word is influenced by the word or words that preceded it. Accordingly, in an example an n-order entropy can be modelled by considering sequences of n symbols, or n-grams.

For example, for sequences of length 2, for each symbol t, all symbols that follow t and their frequencies are recorded. This forms a transition table pᵢ(j) which shows the states possibly following tᵢ, and their probability. p_{i,j} is then given as:

p_{i,j}=pᵢpᵢ(j)

For performance reasons, the available data may be truncated at some offset to produce M, because typically H eventually plateaus. For example and without limiting the present disclosure, it may be possible to limit to the top 50 or 100, etc. most frequently occurring terms without significant loss of accuracy.

Finally in this specific example, to get a normalized value, the metric entropy H_{metric} is calculated at 520 as the ratio between the entropy and the message length:

$${H}_{metric} = \frac{H}{\vert M \vert}$$

In the above examples, it is described that a tokenized version of the content is used when counting the number of occurrences of each unique term in the content. However, the tokenizing of the text may be omitted and the counting of the number of occurrences of terms in the text may be carried out on un-decoded text. This may enable results to be returned more quickly, albeit likely with a lower precision or accuracy in that the results may contain false positives, i.e. content that is indicated as being in or containing a natural language when in fact it does not.

In an example, whichever way the score is obtained, the score is then associated with the item being processed. For the next stage 310, a number of options are available. If the score is high (for example, the entropy value is too high or too low in the case that the entropy is measured), the operating component 104 can make the decision not to forward the item to the indexer 106 for indexing. In that case, only items that are or contain natural language are sent to the indexer 106 for indexing. As an alternative for such items, the item is forwarded with the score for the item to the indexer 106 which incorporates it into the searchable index along with the score for the item. Otherwise, if the score is low (that is, if the entropy value is neither too high or too low, that is, the entropy value for the item is between the upper and lower thresholds for the entropy, in the case that the entropy is measured) the operating component 104 forwards the item to the indexer 106 for indexing. The operating component 104 may also forward the score to the indexer 106 to be associated with the item in the index.

When a user posts a query to the search engine 108, the search engine 108 sorts the set of the items in the index that match the query according to some ranking criterion or criteria. In the present example, the score can be incorporated into the ranking criteria. In particular, items having low scores may be depreciated (that is, lowered in the results ranking) as these are items that the user is likely to have less interest in. This lessens the likelihood that random data or data that is non-natural language text is prominently featured in the search results to the user.

When the search results are presented to the user, items that are likely to be natural language may be highlighted relative to items that are likely not to be natural language. A number of ways of achieving this are possible. For example, items that are likely not to be natural language may be omitted from the search results altogether (and indeed may not have been sent to the indexer 106 in the first place, as discussed above). As another example, as mentioned, items that are likely not to be natural language may be presented lower than items that are likely to be natural language in the search results. As another example, the score or measure of the likelihood that the item is or is not natural language may be presented in the search results alongside the corresponding search result.

The user may be provided with functionality by the search engine 108, for example when initiating a search, to allow the user to select whether non-natural language items are indexed; whether non-natural language items, if indexed, are presented in the search results; and whether non-natural language items, if presented in the search results, are presented lower than natural language items; and whether non-natural language items and/or natural language items are presented in the search results alongside the measure of the likelihood that the item is non-natural language or natural language respectively.

Computing the term distribution, for example by calculating the entropy, allows for several optimizations in a search index. For example, it is possible to omit indexing the item contents when they are deemed to not consist of non-natural language text. In such a case, optionally only index basic metadata, such as for example the file name, may be sent to the indexer 106. As another example, the item is penalized such way that it is not returned amongst the first results for a given query. As yet another example, if natural language and non-natural language are mixed in one item, then the non-natural language sections of the item can be omitted or depreciated during indexing by the indexer 106.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (e.g. a solid-state drive or SSD).

Some examples described herein may be implemented as a distributed system, which may run on plural computers which are connected by a computer network (which may include for example one or more local area networks and the Internet). The different components of the specific examples described herein, such as one or more of the crawler 102, the operating component 104, the indexer 106 and the search engine 108, may be distributed across one or more computers. In general for any of these, there may be one role per computer, several roles per computer, one role spanning several computers, etc.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

What is claimed is:

1. A method of processing digital items, the method comprising:
analyzing content in a digital item to identify individual terms in the content of the digital item;
obtaining a count of at least some of the individual terms in the content of the digital item;
obtaining a measure of the likelihood that the content of the digital item is or contains natural language based on the count of at least some of the individual terms in the content of the digital item; and
if the measure of the likelihood that the content of the digital item is or contains natural language is above a threshold, forwarding the content of the digital item to an indexer of a search engine, the search engine indexer then indexing the content of the digital item such that said content is available to a search engine; and
if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

2. A method according to claim 1, comprising in case (ii) forwarding metadata for the digital item to the search engine indexer, the search engine indexer then indexing the metadata.

3. A method according to claim 1, wherein content for which the measure of the likelihood is above the threshold is highlighted in the search results relative to content for which the measure of the likelihood is below the threshold ranking by ranking content for which the measure of the likelihood is above the threshold higher in the search results than content for which the measure of the likelihood is below the threshold ranking.

4. A method according to claim 1, wherein content for which the measure of the likelihood is above the threshold is highlighted in the search results relative to content for which the measure of the likelihood is below the threshold ranking by indicating in the search results the measure of the likelihood.

5. A method according to claim 1, wherein forwarding the content of the digital item to the search engine indexer if the measure of the likelihood that the content of the digital item is or contains natural language is above a threshold comprises:
forwarding the content of the digital item and the measure of the likelihood to the search engine indexer.

6. A method according to claim 1, wherein the digital item has plural sections of content, and the plural sections of content are processed independently.

7. A method according to claim 1, wherein obtaining the measure of the likelihood that the content of the digital item is or contains natural language is based on the distribution of the count of at least some of the individual terms in the content of the digital item.

8. A method according claim 1, wherein obtaining a measure of the likelihood that the content of the digital item is or contains natural language based on the count of at least some of the individual terms in the content of the digital item comprises:
calculating an entropy of the individual terms in the content of the digital item based on the count of at the least some of the individual terms in the content of the digital item.

9. A method according to claim 8, comprising:
determining that the measure of the likelihood that the content of the digital item is or contains natural language is below a threshold if the entropy is above a first entropy threshold or lower than a second, lower entropy threshold, and
determining that the measure of the likelihood that the content of the digital item is or contains natural language is above a threshold if the entropy is between the first entropy threshold and the second entropy threshold.

10. A non-transitory computer-readable storage medium comprising a set of computer-readable instructions stored thereon, which, when executed by a computer system, cause the computer system to carry out a method of processing of digital items, the method comprising:
analyzing content in a digital item to identify individual terms in the content of the digital item;
obtaining a count of at least some of the individual terms in the content of the digital item;
obtaining a measure of the likelihood that the content of the digital item is or contains natural language based on the count of at least some of the individual terms in the content of the digital item; and
if the measure of the likelihood that the content of the digital item is or contains natural language is above a threshold, forwarding the content of the digital item to an indexer of a search engine, the search engine indexer then indexing the content of the digital item such that said content is available to a search engine; and
if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

11. A non-transitory computer-readable storage medium according to claim 10, wherein the computer-readable instructions are such that the method comprises in case (ii) forwarding metadata for the digital item to the search engine indexer, the search engine indexer then indexing the metadata.

12. A non-transitory computer-readable storage medium according to claim 10, wherein the computer-readable instructions are such that content for which the measure of the likelihood is above the threshold is highlighted in the search results relative to content for which the measure of the likelihood is below the threshold ranking by ranking content for which the measure of the likelihood is above the threshold higher in the search results than content for which the measure of the likelihood is below the threshold ranking.

13. A non-transitory computer-readable storage medium according to claim 10, wherein the computer-readable instructions are such that content for which the measure of the likelihood is above the threshold is highlighted in the search results relative to content for which the measure of the likelihood is below the threshold ranking by indicating in the search results the measure of the likelihood.

14. A non-transitory computer-readable storage medium according to claim 10, wherein the computer-readable instructions are such that forwarding the content of the digital item to the search engine indexer if the measure of the likelihood that the content of the digital item is or contains natural language is above a threshold comprises:
forwarding the content of the digital item and the measure of the likelihood to the search engine indexer.

15. A non-transitory computer-readable storage medium according to claim 10, wherein the computer-readable instructions are such that, in the case that the digital item has plural sections of content, the plural sections of content are processed independently.

16. A non-transitory computer-readable storage medium according to claim 10, wherein the computer-readable instructions are such that obtaining the measure of the likelihood that the content of the digital item is or contains natural language is based on the distribution of the count of at least some of the individual terms in the content of the digital item.

17. A non-transitory computer-readable storage medium according to claim 10, wherein the computer-readable instructions are such that obtaining a measure of the likelihood that the content of the digital item is or contains natural language based on the count of at least some of the individual terms in the content of the digital item comprises:
calculating an entropy of the individual terms in the content of the digital item based on the count of at the least some of the individual terms in the content of the digital item.

18. A non-transitory computer-readable storage medium according to claim 17, wherein the computer-readable instructions are such that the method comprises:
determining that the measure of the likelihood that the content of the digital item is or contains natural language is below a threshold if the entropy is above a first entropy threshold or lower than a second, lower entropy threshold, and
determining that the measure of the likelihood that the content of the digital item is or contains natural language is above a threshold if the entropy is between the first entropy threshold and the second entropy threshold.

19. A computer system comprising:
at least one processor;
and at least one memory including computer program instructions;
the at least one memory and the computer program instructions being configured to, with the at least one processor, cause the computer system to carry out a method of processing digital items, the method comprising:
analyzing content in a digital item to identify individual terms in the content of the digital item;
obtaining a count of at least some of the individual terms in the content of the digital item;
obtaining a measure of the likelihood that the content of the digital item is or contains natural language based on the count of at least some of the individual terms in the content of the digital item; and
if the measure of the likelihood that the content of the digital item is or contains natural language is above a threshold, forwarding the content of the digital item to an indexer of a search engine, the search engine indexer then indexing the content of the digital item such that said content is available to a search engine; and
if the measure of the likelihood that the content of the digital item is or contains natural language is below a threshold, at least one of: (i) forwarding the content of the digital item and the measure of the likelihood to the search engine indexer, the search engine indexer then indexing the content of the digital item and associating the indexed content with the corresponding measure of the likelihood, and, in response to a query to the search engine, returning search results in which content for which the measure of the likelihood is above the threshold is highlighted relative to content for which the measure of the likelihood is below the threshold; and (ii) not forwarding the content of the digital item to the search engine indexer.

20. A computer system according to claim 19, wherein the computer program instructions are such that obtaining a measure of the likelihood that the content of the digital item is or contains natural language based on the count of at least some of the individual terms in the content of the digital item comprises:
calculating an entropy of the individual terms in the content of the digital item based on the count of at the least some of the individual terms in the content of the digital item.
